(19) United States
(12) Patent Application Publication
(10) Pub. No.: US 2013/0094933 A1
(43) Pub. Date: Apr. 18, 2013

(54) STACKING AND UNSTACKING MACHINE, PARTICULARLY FOR INSTRUMENT TRANSFORMER BOXES

(71) Applicants: Zhanhe XU, Wuhan (CN); Luhua ZHANG, Wuhan (CN); Longhua WANG, Wuhan (CN); Yinghui LI, Wuhan (CN)

(72) Inventors: Zhanhe XU, Wuhan (CN); Luhua ZHANG, Wuhan (CN); Longhua WANG, Wuhan (CN); Yinghui LI, Wuhan (CN)

(21) Appl. No.: 13/597,225

(22) Filed: Aug. 28, 2012

(30) Foreign Application Priority Data
Oct. 12, 2011 (CN) 201110307242.1
Oct. 12, 2011 (CN) 201120385672.0

(51) Int. Cl. B65G 57/00; B65G 59/00

(52) U.S. Cl. 414/788.9; 414/788.1

(57) ABSTRACT

A stacking and unstacking machine for transporting instrument transformer boxes, including a main frame, an elevator arranged underneath the main frame, a transporter disposed on the elevator, and a stacking/unstacking device disposed on an upper part of the main frame and above the transporter.

### CROSS-REFERENCE TO RELATED APPLICATIONS

Pursuant to 35 U.S.C. §119 and the Paris Convention Treaty, this application claims the benefit of Chinese Patent Application No. 201110307242.1 filed Oct. 12, 2011, and Chinese Patent Application No. 201120385672.0 filed Oct. 12, 2011, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a device for transporting instrument transformer boxes, and more particularly to a stacking and unstacking machine for transporting instrument transformer boxes.

2. Description of the Related Art

Currently, calibration devices for instrument transformers can synchronously calibrate a group of instrument transformers. However, the transportation of instrument transformers from a warehouse to an auto-calibration line is accomplished manually. Since manual transportation consumes high labor intensity, and the transportation speed is difficult to control, thus, it cannot meet the requirement of the developed auto-calibration system.

The stacking and unstacking machine is a main operating machine in warehouses of modern enterprises, and it is widely used to transport various kinds of packing bags and boxes in the auto-production line of such industries as grain and oil, tobacco, tires, and cement. However, because different stacking and unstacking machines are different in working conditions and requirements, the common stacking and unstacking machine are not applicable to transport instrument transformer boxes.

### SUMMARY OF THE INVENTION

In view of the above-described problems, it is one objective of the invention to provide a stacking and unstacking machine for transporting instrument transformer boxes.

To achieve the above objective, in accordance with one embodiment of the invention, there is provided a stacking and unstacking machine for transporting instrument transformer boxes comprising a main frame, an elevator arranged underneath the main frame, a transporter disposed on the elevator, and a stacking/unstacking device disposed on an upper part of the main frame and above the transporter.

In a class of this embodiment, the stacking/unstacking device comprises a stacking/unstacking frame, a stacking/unstacking frame crossbeam connected to the main frame, and a clamping structure installed on an inner side of the stacking/unstacking frame crossbeam. An upper end of the stacking/unstacking frame hangs on crossbeams of a roof of the main frame, and a lower end of the stacking/unstacking frame is connected to the stacking/unstacking frame crossbeam. The stacking/unstacking device is used to stack and unstack the instrument transformer boxes.

In a class of this embodiment, the clamping structure comprises an actuating cylinder, a cylinder actuating arm, a linkage rod, and a clamping block; an output end of the actuating cylinder is connected to one end of the cylinder actuating arm, and the other end of the cylinder actuating arm is connected to the linkage rod which is in rigid connection with the clamping block. Optionally, other types of clamping structures can also be employed.

In a class of this embodiment, the stacking/unstacking frame comprises a guiding baffle transversely arranged in a conveying direction of the instrument transformer boxes to prevent the instrument transformer boxes of upper stories from sliding. The number, size, and position of the guiding baffle can be adjusted according to practical requirements.

In a class of this embodiment, a distance between two stacking/unstacking frame crossbeams corresponds to the width of the instrument transformer boxes, whereby reducing the moving distance of the clamping block and saving time and money.

In a class of this embodiment, at least two clamping blocks are employed, and the number and position of the clamping blocks can be designed according to practical requirements.

In a class of this embodiment, the shape of the clamping block matches with the shape of a handle on the instrument transformer box whereby forming a clamping member, thus the clamping strength between the clamping block and the instrument transformer box is improved.

In a class of this embodiment, the elevator comprises at least two gears for adjustment of ascending height and specifically locating the instrument transformer boxes during the process of stacking/unstacking. The ascending height and number of the gears can be designed according to the height and number of the instrument transformer boxes during the process of stacking/unstacking.

In a class of this embodiment, the guiding baffle is connected to the main frame via a support bar, to improve the connection strength of the guiding baffle, the stacking/unstacking frame, and the stacking/unstacking frame crossbeam.

Advantages of the invention are summarized below: first, the machine of this invention has realized the automatic stacking/unstacking of instrument transformer box through the stacking/unstacking device; second, the guiding baffle can effectively prevent the instrument transformer boxes from sliding during the process of stacking/unstacking; third, the elevator comprises at least two gears to specifically locate the position of the instrument transformer boxes when stacking/unstacking, and the ascending height and number of the gears can be designed according to the height and number of the instrument transformer boxes; finally, the shape of the clamping block matches with the shape of the handle on the instrument transformer box whereby forming a clamping member, thus the clamping strength between the clamping block and the instrument transformer box is improved.

The stacking and unstacking machine has a simple structure, convenient operation, low requirement of labor intensity, and easy control of transportation speed.

### BRIEF DESCRIPTION OF THE DRAWINGS

FIG. 1 is a schematic diagram of a stacking and unstacking machine for transporting instrument transformer boxes in accordance with one embodiment of the invention;

FIG. 2 is a side view of FIG. 1;

FIG. 3 is a top view of FIG. 1;

FIG. 4 is a cross-sectional view taken from line A-A of FIG. 1;

FIG. 5 is a cross-sectional view taken from line B-B of FIG. 1; and

FIG. 6 is a three dimensional schematic diagram of a stacking and unstacking machine for transporting instrument transformer boxes in accordance with one embodiment of the invention.

In the drawings, the following reference numbers are used: 1. Main frame; 2. Elevator; 3. Transporter; 4. Stacking/unstacking device; 4a. Stacking/unstacking frame; 4b. Stacking/unstacking frame crossbeam; 4c. Clamping structure; 4c1. Actuating cylinder; 4c2. Cylinder actuating arm; 4c3. Linkage rod; 4c4. Clamping block; 4d. Guiding baffle; 5. Instrument transformer box.

### DETAILED DESCRIPTION OF THE EMBODIMENTS

To further illustrate the invention, experiments detailing a stacking and unstacking machine for transporting instrument transformer boxes are described below. It should be noted that the following examples are intended to describe and not to limit the invention.

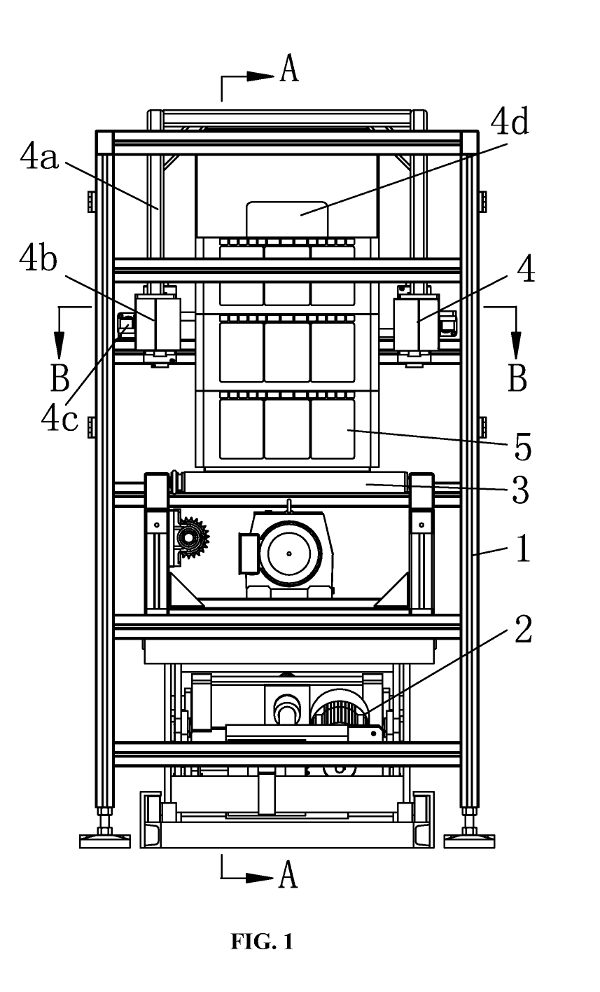

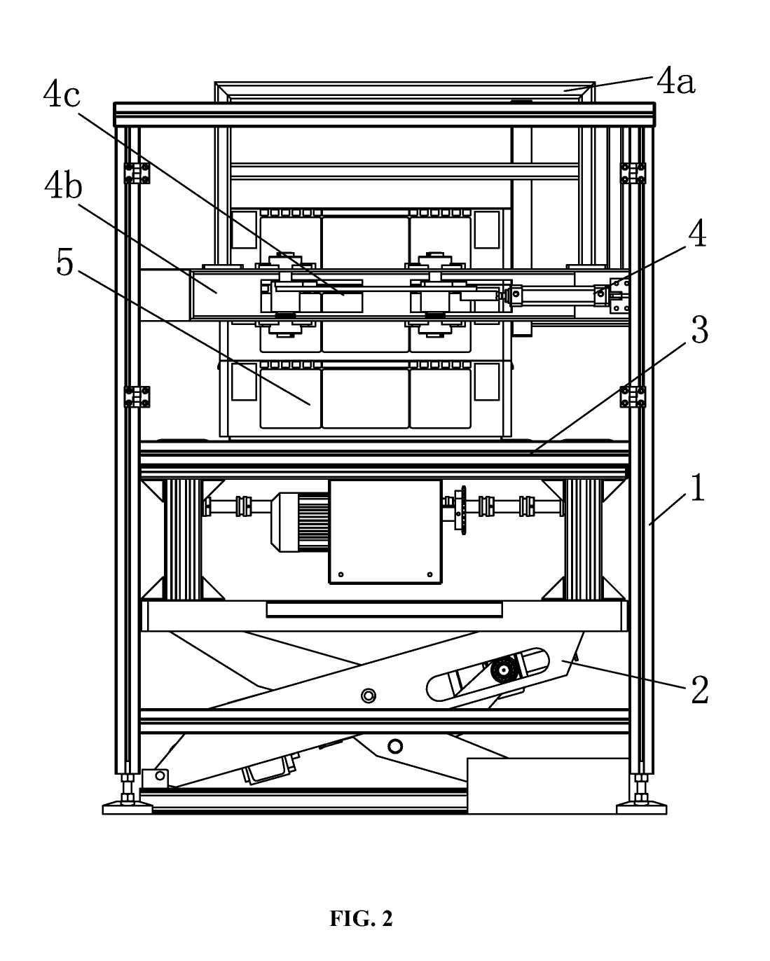

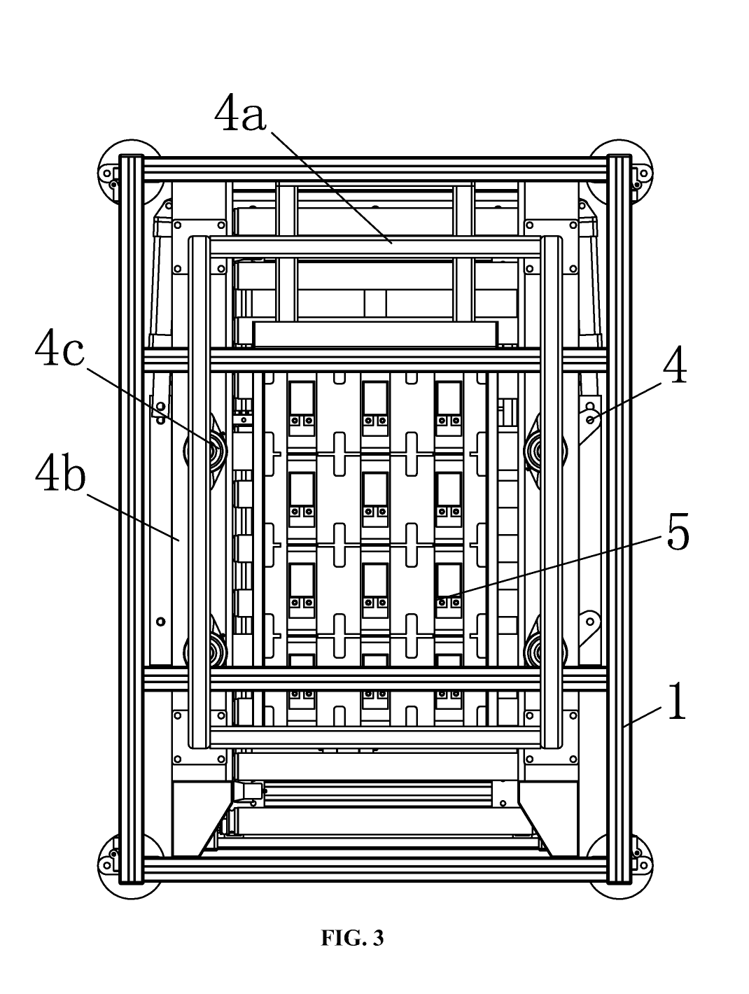

As illustrated in FIG. 1, a stacking and unstacking machine for transporting instrument transformer boxes comprises a main frame 1, an elevator 2 arranged underneath the main frame 1, a transporter 3 disposed on the elevator 2, and a stacking/unstacking device 4 disposed on an upper part of the main frame 1 and above the transporter 3. The stacking/unstacking device 4 comprises a stacking/unstacking frame 4a, a stacking/unstacking frame crossbeam 4b connected to the main frame 1, and a clamping structure 4c installed on the inner side of the stacking/unstacking frame crossbeam 4b. The upper end of the stacking/unstacking frame 4a hangs on crossbeams of the roof of the main frame 1, and the lower end of the stacking/unstacking frame 4a is connected to the stacking/unstacking frame crossbeam 4b. The stacking/unstacking device 4 is used to stack and unstack the instrument transformer boxes 5 (referring to FIGS. 2-3).

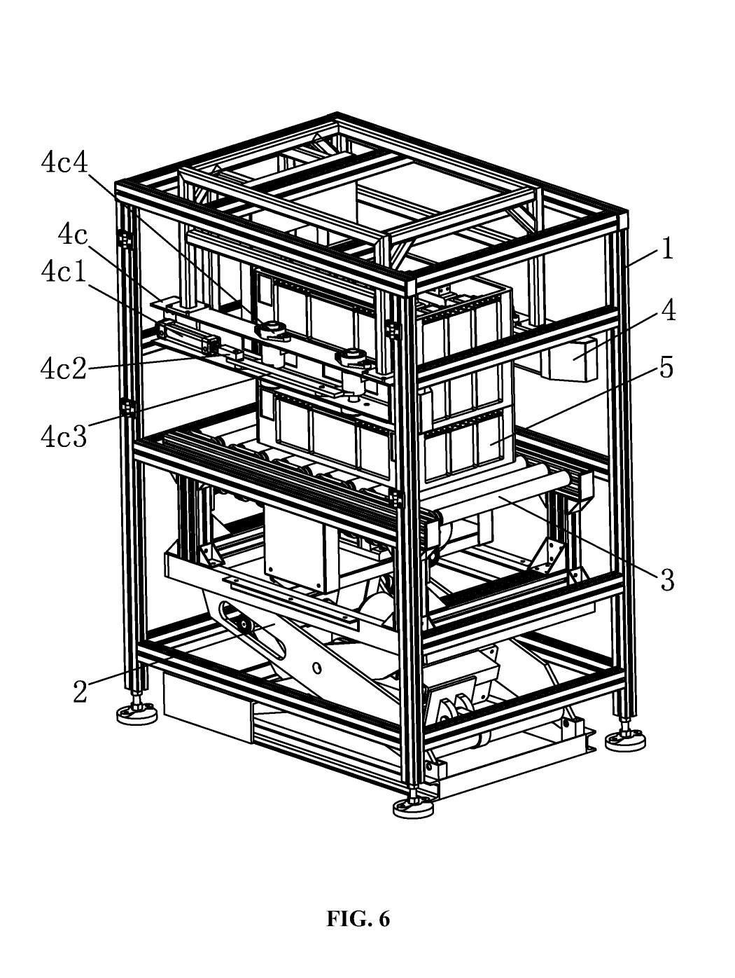

As shown in FIG. 6, the clamping structure 4c comprises an actuating cylinder 4c1, a cylinder actuating arm 4c2, a linkage rod 4c3, and a clamping block 4c4. The output end of the actuating cylinder 4c1 is connected to one end of the cylinder actuating arm 4c2, and the other end of the cylinder actuating arm 4c2 is connected to the linkage rod 4c3 which is in rigid connection with the clamping block 4c4. Optionally, other types of clamping structures can also be employed.

As shown in FIG. 1, the stacking/unstacking frame 4a comprises a guiding baffle 4d transversely arranged in a conveying direction of the instrument transformer box 5 to prevent instrument transformer boxes of upper stories from sliding. The number, size, and position of the guiding baffle 4d can be adjusted according to practical requirements. The guiding baffle 4d is connected to the main frame 1 via a support bar, to improve the connection strength of the guiding baffle 4d, the stacking/unstacking frame 4a, and the stacking/unstacking frame crossbeam 4b (referring to FIGS. 2-5).

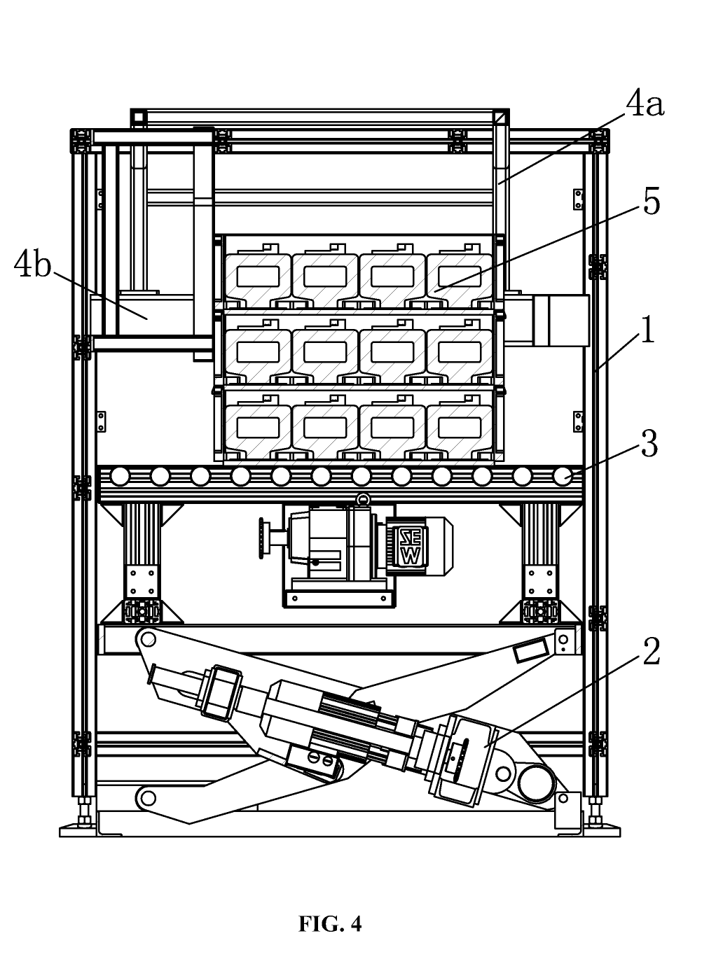

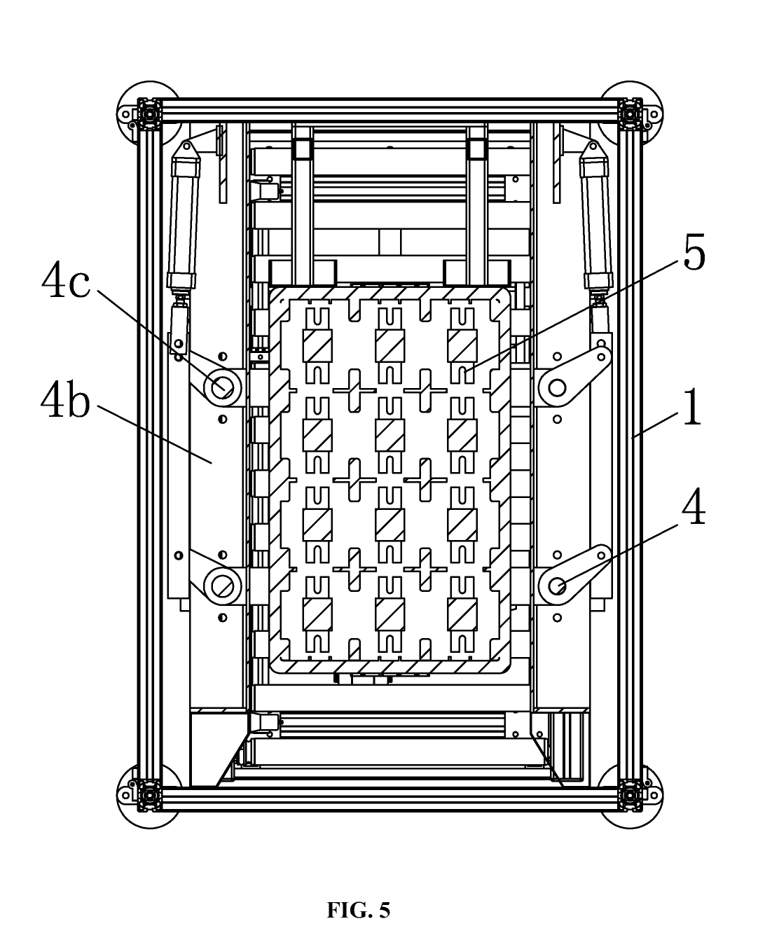

As shown in FIG. 1, the distance between each stacking/unstacking frame crossbeam 4b corresponds to the width of the instrument transformer box, whereby reducing the moving distance of the clamping block 4c4 and saving time and money. Four clamping blocks are employed, and arranged in symmetry. Optionally, the number and position of the clamping blocks can be designed according to the practical requirements. The shape of the clamping block matches with the shape of a handle on the instrument transformer box whereby forming a clamping member, thus the clamping strength between the clamping block and the instrument transformer box is improved (referring to FIGS. 4-5).

As shown in FIG. 2, the elevator 2 comprises three gears for adjustment of ascending height, thus the stacking/unstacking device 4 can specifically locate instrument transformer boxes 5 during the process of stacking/unstacking. Optionally, the ascending height and number of the gear can be designed according to the height and number of the instrument transformer boxes 5 during the process of stacking/unstacking (referring to FIG. 4 and FIG. 6).

In use, the stacking and unstacking machine can be installed directly on the auto-calibration line. First, the machine of this invention has realized the automatization of the stacking/unstacking of instrument transformer box 5 through the stacking/unstacking device 4; second, the guiding baffle 4d can effectively prevent instrument transformer boxes 5 from sliding in the stacking/unstacking process; third, the elevator 2 comprises at least two ascending gears and thus can specifically locate the position of instrument transformer boxes 5 when stacking/unstacking, and the ascending height and number of the gears can be designed according to the height and number of the instrument transformer boxes 5; finally, the shape of the clamping block 4c4 matches with the shape of handles on the instrument transformer box 5 whereby forming a clamping member, thus the clamping strength between the clamping block and the instrument transformer box is improved. The stacking and unstacking machine has a simple structure, convenient operation, low requirement of labor intensity, and easy control of transportation speed.

When Stacking:

Stacking a first storey: first, the transporter 3 transports a first instrument transformer box 5 to the operating position of the stacking and unstacking machine, and stops working; then, the elevator 2 ascends to a third gear (a first gear is the lowest, a second gear is a height of one instrument transformer box higher than the first gear, and a third gear is a height of one instrument transformer box higher than the second gear), the actuating cylinder 4c1 actuates the clamping block 4c4 to clamp the first instrument transformer box; finally, the elevator 2 returns to the original position (the first gear), and the stacking of the first storey is accomplished.

Stacking a second storey: first, the transporter 3 transports a second instrument transformer box 5 to the operating position of the stacking and unstacking machine, and stops working again; then, the elevator 2 ascends to the second gear, and the actuating cylinder actuates the clamping block 4c4 release the first instrument transformer box 5 which then stacks on the second instrument transformer box 5; thereafter, the elevator 2 ascends to the third gear, and the actuating cylinder 4c1 actuates the clamping block 4c4 to clamp the second instrument transformer box 5 (the instrument transformer box of the second storey); finally, the elevator 2 returns to the original position (the first gear), and the stacking of the second storey is accomplished.

Stacking a third storey: first, the transporter 3 transports a third instrument transformer box 5 to the operating position of the stacking and unstacking machine, and stops working again; then, the elevator 2 ascends to the second gear, and the actuating cylinder actuates the clamping block 4c4 release the second instrument transformer box 5, to make the former two instrument transformer boxes 5 stack on the third instrument transformer box 5; finally, the elevator 2 returns to the original position (the first gear), thus the stacking of the third storey is accomplished.

Transporting process: the stacked instrument transformer boxes of three stories are transported to an expected position by the transporter 3, and thus the stacking process of a stack of instrument transformer boxes is accomplished.

When Unstacking:

Unstacking the third storey: first, the transporter 3 transports a stack of instrument transformer boxes to the operating position of the stacking and unstacking machine and stops working; then, the elevator 2 ascends to the second gear, and the actuating cylinder 4c1 actuates the clamping block 4c4 to clamp the second instrument transformer box 5; thereafter, the elevator 2 returns to the original position (the first gear), and the transporter 3 transports the third instrument transformer box 5 to a next operating position, thus the unstacking of the third instrument transformer box 5 is accomplished.

Unstacking the second storey: first, the elevator 2 ascends to the third gear, and the actuating cylinder 4c1 actuates the clamping block 4c4 to release the second instrument transformer box 5, and thus two stories of instrument transformer boxes fall on the transporter 3; then, the elevator descends to the second gear; thereafter, the actuating cylinder 4c1 actuates the clamping block 4c4 to clamp the first instrument transformer box 5; finally, the elevator 2 returns to the original position (the first gear), and the transporter 3 transports the second instrument transformer box 5 to the next operating position, thus the unstacking of the second instrument transformer box 5 is accomplished.

Unstacking the first storey: first, the elevator 2 ascends to the third gear, and the actuating cylinder 4c1 actuates the clamping block 4c4 to release the first instrument transformer box 5 on the transporter 3; then, the elevator 2 returns to the original position (the first gear); finally, the transporter 3 transports the first instrument transformer box 5 to the next operating position, thus the unstacking of the first instrument transformer box 5 is accomplished.

In the process of stacking and unstacking, the number of the stories of the instrument transformer boxes is designed as needed.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A stacking and unstacking machine, comprising:
a) a main frame;
b) an elevator arranged underneath the main frame;
c) a transporter disposed on the elevator; and
d) a stacking/unstacking device disposed on an upper part of the main frame and above the transporter.

2. The machine of claim 1, wherein
the stacking/unstacking device comprises a stacking/unstacking frame, a stacking/unstacking frame crossbeam connected to the main frame, and a clamping structure installed on an inner side of the stacking/unstacking frame crossbeam; and
an upper end of the stacking/unstacking frame hangs on crossbeams of a roof of the main frame, and a lower end of the stacking/unstacking frame is connected to the stacking/unstacking frame crossbeam.

3. The machine of claim 2, wherein
the clamping structure comprises an actuating cylinder, a cylinder actuating arm, a linkage rod, and a clamping block; and
an output end of the actuating cylinder is connected to one end of the cylinder actuating arm, and the other end of the cylinder actuating arm is connected to the linkage rod which is in rigid connection with the clamping block.

4. The machine of claim 2, wherein the stacking/unstacking frame comprises a guiding baffle transversely arranged in a conveying direction of instrument transformer boxes to prevent the instrument transformer boxes of upper stories from sliding.

5. The machine of claim 2, wherein a distance between two stacking/unstacking frame crossbeams corresponds to a width of an instrument transformer box.

6. The machine of claim 3, wherein at least two clamping blocks are employed.

7. The machine of claim 3, wherein a shape of the clamping block matches with that of a handle on an instrument transformer box whereby forming a clamping member.

8. The machine of claim 6, wherein a shape of the clamping block matches with that of a handle on an instrument transformer box whereby forming a clamping member.

9. The machine of claim 1, wherein the elevator comprises at least two gears for adjustment of ascending height.

10. The machine of claim 4, the guiding baffle is connected to the main frame via a support bar.
